(19) United States
(12) Patent Application Publication
(10) Pub. No.: US 2020/0262128 A1
(43) Pub. Date: Aug. 20, 2020

(54) MOLD BASE PROVIDED WITH A CENTRAL MOVABLE INSERT

(71) Applicant: SIDEL PARTICIPATIONS, Octeville-sur-mer (FR)

(72) Inventors: Pierrick PROTAIS, Octeville-sur-Mer (FR); Mickaël LETESTU, Octeville-sur-Mer (FR); Camille GUITON, Octeville-sur-Mer (FR)

(21) Appl. No.: 16/061,180

(22) PCT Filed: Dec. 15, 2016
(86) PCT No.: PCT/FR2016/053453

§ 371 Date: Jun. 11, 2018

(30) Foreign Application Priority Data
Dec. 16, 2015 (FR) 1562529

(51) Int. Cl. B29C 49/48; B29C 49/12

(52) U.S. Cl. CPC B29C 49/4802; B29K 2067/003; B29C 2049/4807; B29C 49/12

(57) ABSTRACT

A method for producing a container provided with a base, in a mold that includes a base with a base block with a raised molding face and a central opening, and an insert mounted in the central opening. The insert has an end face with the imprint of a central area of the base of the container, movable between: a retracted position with the end face extending in the extension of the molding face, thus completing therewith the imprint of the base of the container; a protruding position with the insert protruding relative to the central opening. A step of boxing the central area of the base of the container includes moving the insert to the protruding position to exert pressure against the central area of the base and increase the clearance of the central area relative to the clearance at the end of the blowing.

The invention relates to the forming of containers by blow molding or stretch blow molding blanks made of plastic material, such as polyethylene terephthalate (PET), with the term “blank” designating a preform (ordinarily obtained by injection) or an intermediate container that has undergone a preliminary blow-molding operation starting from a preform.

A container comprises a body, which is generally cylindrical in shape and which extends along a main axis, a shoulder that forms a narrowing starting from an upper end of the body, an open neck extending the shoulder to make possible the filling and the emptying of the container, and a bottom that closes the body at a lower end of the latter.

The forming is generally carried out within a mold that delimits a cavity that bears the impression of the container. Such a mold commonly comprises a side wall that bears the impression of the body and the shoulder (with this side wall being subdivided into two half-molds that are mutually articulated to make it possible to insert a blank into the mold), and a mold base that bears the impression of the bottom of the container, positioned in an opening that is made between the half-molds.

The preform, after having been heated to a temperature that is higher than the glass transition temperature of its material (a PET preform, whose glass transition temperature is approximately 80° C., is ordinarily heated to a temperature that is higher than 100° C., typically on the order of 120° C.), is inserted hot into the mold. A pressurized gas (such as air) is then injected therein to flatten the material, made soft by the heating, against the wall and the mold base and thus to impart to the preform the impression of the container.

The bottom of the container is a critical area because its structural strength depends on the stability of the container that is placed on a surface, be it in particular a conveyor during operations of handling the container following its filling or a table on which a user places the container.

Innumerable shape tricks have been thought up to make the bottoms of containers rigid, cf., for example, the patents EP 1 945 518 (in the name of and on behalf of the applicant, describing a petaloid bottom and its associated mold) and EP 2 580 132 (also in the name of and on behalf of the applicant, describing a bottom that is equipped with star-shaped stiffeners). Most of them nevertheless have the following in common:
A peripheral seat that defines a placement plane for the container;
A central arch, which extends on the inside to the seat and projects toward the inside of the container and whose top part (generally in the center of the arch) extends at a distance from the placement place, measured axially, called “clearance.”

The lightening of the containers, imposed by the environmental standards, and the bottlers' search for ways to save material tend to weaken the bottom and, despite the shape tricks mentioned above, arch-weakening phenomena are observed after the container is removed from the mold. This phenomenon has even been observed in certain petaloid bottoms, nevertheless known to be rigid, whose clearance gradually decreases, to the point where it is eliminated (with the arch rejoining the placement pose), and even to the point where it becomes negative (the arch forming a protrusion beyond the placement plane, toward the outside of the container). The result is a lack of stability of the bottom, with the container then being likely to fall. An explanation of this phenomenon is the increase in production rates (several thousands of containers produced per hour and per mold), which brings about a reduction in the manufacturing cycle times of each container, and therefore a reduction in the contact time of the container with the mold. Consequently, the bottom of the container that is leaving the mold is also very warm and deforms during its cooling by freely relaxing the constraints brought about by the blow molding.

A first objective is to propose a solution for reducing the risk of settling of the arch.

A second objective is, more specifically, to propose a solution that makes it possible to keep the clearance at a strictly positive value.

A method for manufacturing a container that has a bottom that is provided with a seat and a central area that is raised in relation to the seat, by blow molding or stretch blow molding, in a mold, from a blank made of plastic material that was heated in advance to a temperature that is higher than the glass transition temperature of the material is proposed, which method comprises:
An operation for inserting the blank into said mold, which mold comprises a side wall that bears the impression of a body of the container and a mold base that completes, with the side wall, the impression of the container that is to be obtained, with this mold base comprising a base unit that has a molding face in relief bearing the impression of at least the seat of the container, and is provided with a central opening, with this mold base also comprising an insert, mounted in the central opening and provided with an end face that bears the impression of the central area of the bottom of the container, which insert can be moved in relation to the unit between:
A retracted position in which the end face extends in continuation of the molding face of the unit, thus completing with the base unit the impression of the bottom of the container;
A protruding position in which the insert projects in relation to the central opening; which method being characterized in that it also comprises:
A pressurization phase that comprises the injection, in the blank, in the retracted position of the insert, of a pressurized fluid to form the container;
A depressurization phase that comprises the linking of the thus formed container with the atmosphere,
A boxing operation of the central area of the bottom of the container that is thus formed and that consists, during or after the depressurization phase, in moving the insert toward its protruding position in such a way as to exert pressure against said central area of the bottom of the container and to increase the clearance of said central area in relation to the clearance that it has at the end of the blow molding.

Such a method makes it possible to obtain a container that has an increased clearance at the outlet of the mold. The filling of the container can cause, by creep (in particular under high temperature and/or pressure conditions), a weakening of the central area of the bottom, but the clearance, even thus decreased, remains positive, enhancing the stability of the container.

Various additional characteristics can be provided, by themselves or in combination:
The travel of the insert between its retracted position and its protruding position is between 2 mm and 15 mm, and, for example, approximately 5 mm;

In the second place, a mold base for the implementation of the method according to the invention is proposed, in which:
The insert comprises a piston that is mounted in translation in a jacket that is integral with the base unit;
The mold base comprises a support on which the base unit is mounted, and the jacket is at least in part formed in said support;
The mold base comprises a fluid circuit, which includes, for example, a conduit that is formed in the insert for the circulation of a fluid;
The insert is provided with radial perforations that make the conduit empty onto an outer face of the insert, in the vicinity of the end face;
The conduit is formed by a single part and comprises an upstream section and a downstream section that are separated by a fabric;
The insert is produced by additive manufacturing.

Other objects and advantages of the invention will become evident from the description of an embodiment, given below with reference to the accompanying drawings in which:

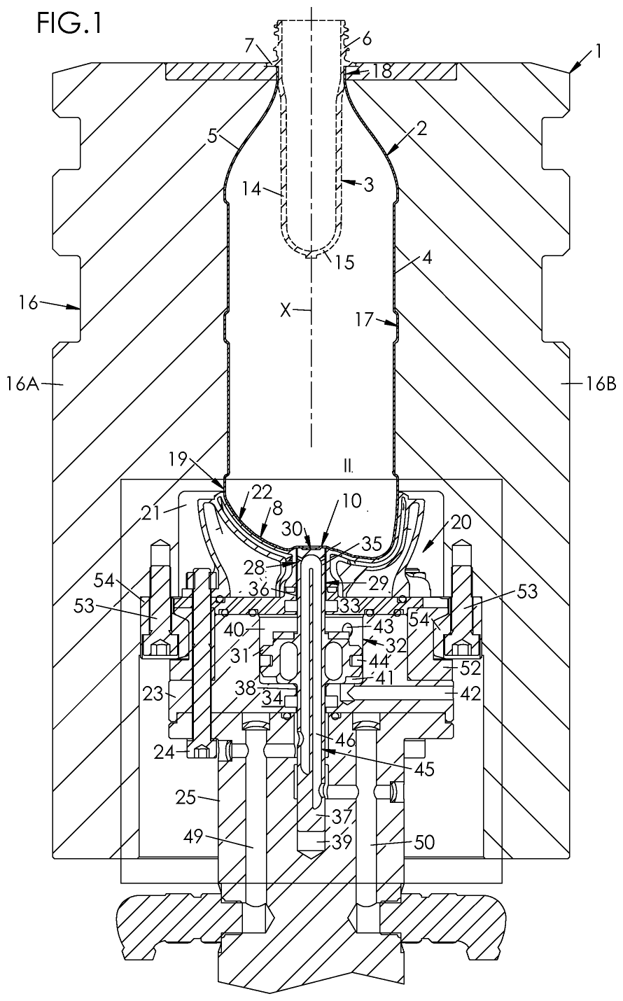

FIG. 1 is a cutaway view of a mold for the manufacturing of a container according to the method of the invention, which mold base is equipped with a movable insert that is mounted in the retracted position;

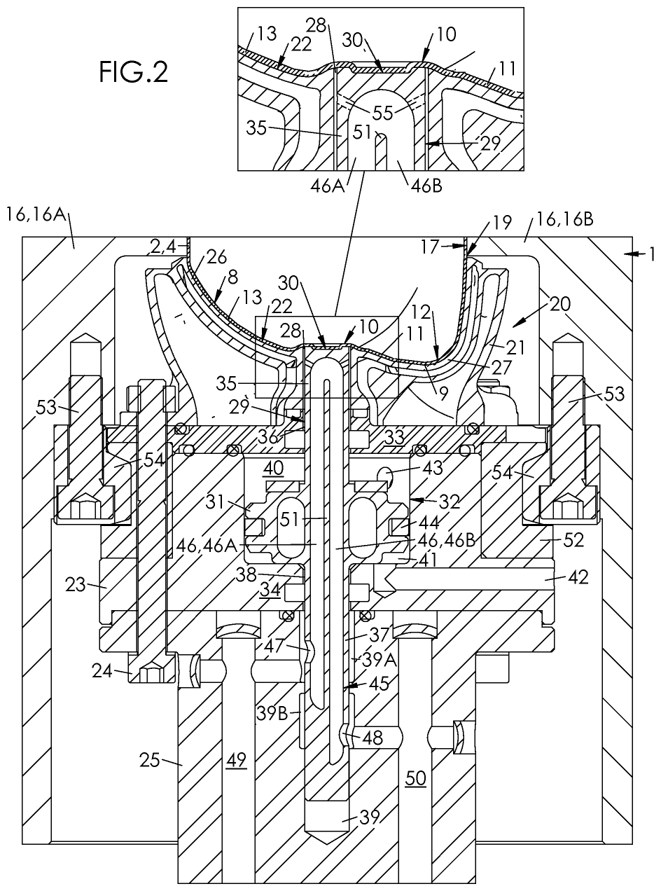

FIG. 2 is a detail view, enlarged, of the mold of FIG. 1 according to the inset II, with, in an inset, an additional detail enlarged even further;

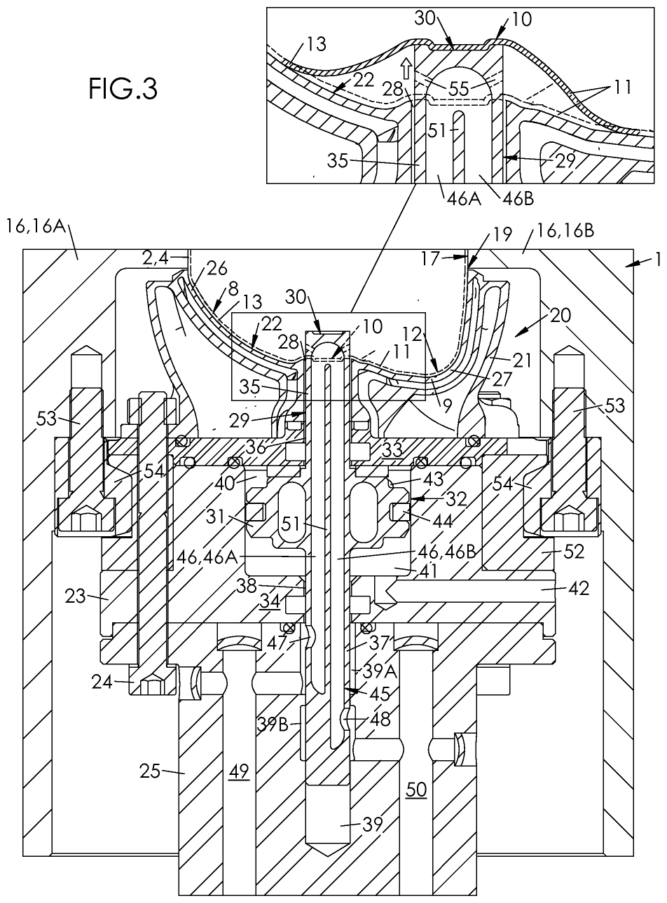

FIG. 3 is a figure that is similar to FIG. 2, showing the insert in the protruding position;

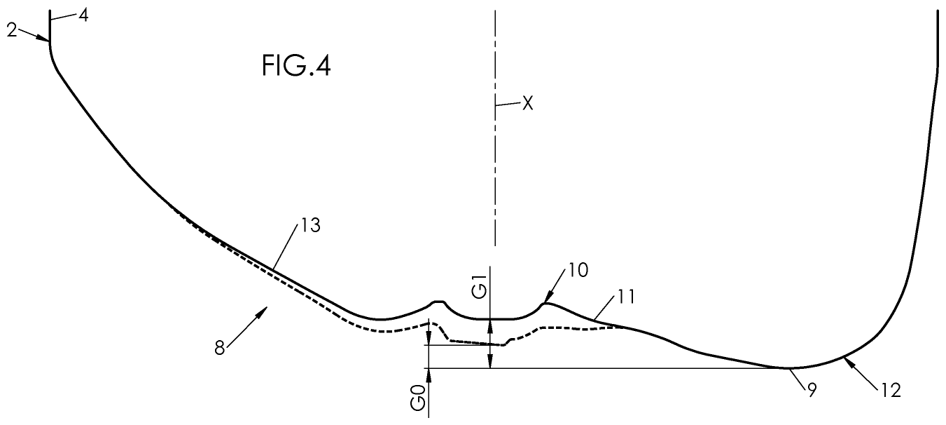

FIG. 4 is a cutaway view of the bottom of a container that is formed in the mold that is illustrated in FIGS. 1 to 3.

FIG. 1 shows a mold 1 for the forming of a container 2 by blow molding or stretch blow molding starting from a blank 3 made of plastic material (in particular polyethylene terephthalate or PET).

The blank 3 can be an intermediate container that has undergone a first blow-molding operation starting from a preform. It can also be, as in the illustrated example, a crude injection preform (seen in dotted lines in FIG. 1).

The container 2 comprises an essentially cylindrical body 4 that extends along a main axis X, a shoulder 5 that extends, by narrowing, in continuation of the body 4 at an upper end of the latter, a neck 6 that is open at an upper end of the shoulder 5, from which it is separated by a collar 7, and a bottom 8 that closes the body 4 at a lower end of the latter. The bottom 8 has a peripheral seat 9 by which the container 2 is designed to rest on a flat surface such as a table, and a central area 10 (where an injection pellet of the preform 3 is found in particular), raised in relation to the seat 9 and which the latter adjoins via an arch 11.

According to an embodiment that is illustrated in the figures, the bottom 8 of the container 2 is petaloid. It comprises alternating spaced feet 12, ending by ends that together form (although in a discrete manner in the mathematical meaning of the term) the seat 9, and valleys 13 with an essentially circular radial cross-section that radiate from the central area 10 to the body 4.

The preform 3 comprises a body 14 that is essentially tubular in shape, designed to form the body 4 and the shoulder 5 of the container 2, a neck 6 that is that of the container 2 and remains unchanged during the forming, and a hemispherical bottom 15 that is designed to form the bottom 8 of the container 2.

The mold 1 comprises a side wall 16 that defines a cavity 17 that bears the impression of the body 4 and the shoulder 5 of the container 2. The side wall 16 extends along a main axis that, when the container 2 is formed, is combined with the main axis X of the latter. Below, the expression “main axis” refers equally to the axis of the container or that of the side wall 16.

According to a conventional embodiment, the side wall 16 is subdivided into two half-molds 16A, 16B that are movable in relation to one another, for example by being mutually articulated around a hinge that is parallel to the main axis X, between an open position in which the two half-molds are separated angularly from one another to make possible the insertion of the preform 3 and the evacuation of the container 2, and a closed position in which the two half-molds are flattened against one another to define together the cavity 17.

The side wall 16 defines an upper opening 18, by which the preform 3 is suspended by its collar 7, and an opposite lower opening 19.

The mold 1 is also equipped with a mold base 20 that comprises, in the first place, a base unit 21 (made of, for example, steel or an aluminum alloy) having a molding face 22 in relief bearing the impression of a portion of the bottom 8 that comprises the seat 9 and the arch 11, with the exception, however, of the central area 10.

The base unit 21 is attached to a support 23 that is itself mounted (for example, by means of a screw 24) on a stand 25 that is translationally movable in relation to the side wall 16 between a loading/unloading position in which the unit 21 is separated from the cavity 17 for making possible the evacuation of the container 2 that is formed and the installation of a preform 3, and a forming position (illustrated in FIGS. 1, 2 and 3) in which the molding face 22 is to seal the lower opening 19 to complete, with the cavity 17, the impression of the container 2 that is to be formed.

According to an embodiment that is illustrated in the figures, where the container 2 has a petaloid bottom 8, the molding face 22 of the base, bearing the impression of the latter, comprises alternating ribs 26 (bearing the impression of the valleys 13) and hollow reserves 27 (each forming a seat area) bearing the impression of the feet 12 (for example, five in number), which extend between the ribs 26.

As can be seen in the figures, and more particularly in FIGS. 2 and 3, the base unit 21 is provided with a central opening 28 that extends around the main axis X. According to an embodiment, this opening 28 has a circular transverse cross-section, but this shape is not limiting.

The mold base 20 comprises, in the second place, an insert 29 that is mounted in translation in the central opening 28. This insert 29 is provided with an end face 30 that bears the impression of the central area 10 of the bottom 8 of the container 2.

The insert 29 is movable (in axial translation, i.e., parallel to the main axis X) in relation to the base unit 21, between:
A retracted position (FIGS. 1, 2) in which the end face 30 extends in continuation of the molding face 22 of the unit 21, thus completing with the latter the impression of the bottom 8 of the container 2, and
A protruding position (FIG. 3) in which the insert 29 projects in relation to the central opening 28, axially toward the cavity 17, with the end face 30 being offset axially in relation to the central opening 28 in the direction of the upper opening 18 of the mold.

The travel of the insert 29 between its retracted position and its protruding position is advantageously between 2 mm and 15 mm, and is, for example, approximately 5 mm.

According to an embodiment that is illustrated in the figures, the insert 29 integrates a piston 31 that is mounted in translation in a jacket 32 that is integral with the base unit 21. More specifically, in the illustrated example, the jacket 32 is formed in the support 23 and is delimited axially, on the one hand toward the top (in the direction of the base unit 21) by an upper wall 33 that is formed by a crosspiece that is inserted between the support 23 and the base unit 21, and, on the other hand toward the base by an opposite lower wall 34 that is formed in the support 23.

As can be seen in FIG. 2, the insert 29 comprises an upper cylindrical shaft 35 that projects toward the top starting from the piston 31 and at the end of which the end face 30 is formed. The upper shaft 35 traverses the upper wall 33 through a central opening 36 that is made in the latter.

According to an embodiment that is illustrated in FIG. 2, the insert 29 also comprises a lower shaft 37 that projects toward the base (i.e., opposite the upper shaft 35), starting from the piston 31. The lower shaft 37 traverses the lower wall 34 through a central opening 38 that is made in the latter.

In addition, as can also be seen in FIG. 2, the stand 25 can be perforated by a bore 39 in which the lower shaft 37 is mounted to slide, play being provided between the bore 39 and the lower shaft 37. The bore 39 advantageously comprises an upper portion 39A and a lower portion 39B that are isolated from one another by an annular shoulder that projects radially and that comes into contact (preferably with insertion of a sealing joint) with the lower shaft 37.

In the jacket 32, the piston 31 delimits an upper chamber 40, beside the upper wall 33, and a lower chamber 41, beside the lower wall 34. A primary fluid control conduit 42 is formed in the support 23 and empties, via the lower wall 34, into the lower chamber 41, to inject a pressurized fluid (such as air or oil) into the latter, which fluid forces the piston 31 to retract toward the upper wall 33 and therefore the insert 29 toward its protruding position.

The cylinder that consists of the piston 31 and the jacket 32 can be of the single-action type; in this case, the mold base 20 comprises one (or more) return spring(s) that is/are inserted between the upper wall 33 and the piston 31, which permanently force(s) the latter toward the lower wall 34 and therefore the insert 29 toward its retracted position.

However, as in the illustrated example, the cylinder that consists of the piston 31 and the jacket 32 can be of the double-action type: a secondary fluid control conduit 43 is formed in the support 23 and empties radially into the upper chamber 40, to inject into the latter a pressurized fluid (such as air or oil), which forces the piston 31 to retract toward the lower wall 34 and therefore the insert 29 toward its retracted position.

Thus, to place the insert 29 in its protruding position, a pressurized fluid (such as air or oil) is injected into the lower chamber 41, via the primary control conduit 42 (and by means of, for example, a hose that is attached to the support 23 by means of a connector), which fluid forces the piston 31 to retract toward the upper wall 33 (and therefore the insert 29 toward its protruding position) while the pressure in the lower chamber 41 is simultaneously released.

In contrast, to place the insert 29 in the retracted position, the pressure is released in the lower chamber 41, while a pressurized fluid (such as air or oil) is injected into the upper chamber 40, via the secondary control conduit 43 (and by means of, for example, a hose that is attached to the support 23 by means of a connector), which fluid forces the piston 31 to retract toward the lower wall 34 (and therefore the insert 29 toward its retracted position).

The sealing between the two chambers 40, 41 is advantageously produced by means of an annular segment 44 that is housed in a groove that is made in a peripheral manner in the piston 31.

As a variant, the movement of the insert 29 can be controlled by mechanical and non-pneumatic (or hydraulic) means, for example by a cam. For this purpose, a lower end of the insert 29 can carry a cam follower (such as a roller), which works with a cam groove, with the permanent contact of the cam follower with the cam groove being ensured by, for example, a return spring. The cam groove has an upper section, which moves the cam follower toward the top (and therefore the insert 29 toward its protruding position), and a lower section, which makes it possible for the cam follower to come down (and therefore for the insert 29 to return toward its retracted position).

According to a preferred embodiment, the mold base 20 comprises a circuit 45 for heat regulation of the insert 29, designed to keep the latter either at a moderate temperature (typically between 5° C. and 30° C., and preferably between 10° C. and 20° C.) when the insert 29 is to be cooled, or at a high temperature (typically between 80° C. and 120° C.) when the insert 29, in contrast, is to be heated, in particular in the case of a heat-setting of the bottom 8 of the container 2. This circuit 45 is, for example, of the fluid type, and then comprises a conduit 46 that is formed in the insert 29 for the circulation, inside of the latter, of a coolant.

As can be seen in particular in FIG. 2, the conduit 46 has an upstream section 46A, which empties into the upper portion 39A of the bore 39 via an upstream opening 47 that is perforated radially in the insert 29, and a downstream section 46B, which empties into the lower portion 39B of the bore 39 via a downstream opening 48, it also being perforated radially in the insert 29.

The heat regulation circuit 45 also comprises a feed pipe 49 that is formed (for example by at least one perforation) in the stand 25 and that empties into the upper portion 39A of the bore 39, and a drain pipe 50 that is also formed (for example, by at least one perforation) in the stand 25 and that empties into the lower portion 39B of the bore 39.

To facilitate the fluid circulation within the insert 29, the conduit 46 is advantageously formed in a single piece, with the upstream section 46A and the downstream section 46B being separated by a fabric 51. If, as in the illustrated example, the insert 29 consists of a single piece, this structure cannot be manufactured by machining. To obtain it, it is necessary to produce the insert 29 by additive manufacturing. More specifically, to produce the insert 29 in a metal material, for example steel or in an aluminum alloy, it is possible to use the technique of three-dimensional printing by powdered laser sintering (in English: “selective laser sintering” or SLS).

As can be seen in FIGS. 2 and 3, the base unit 21 is mounted, with insertion of the crosspiece that forms the upper wall 33, on the support 23 in which the insert 29 was mounted in advance. As illustrated, an annular centering ring 52 provided with a peripheral groove is advantageously mounted on the support 23. The mold base 20 that is thus formed by assembly of the base unit 21, the crosspiece that forms the upper wall 33, and the insert 29 is, with the support 23 and the ring 52, attached rigidly to the stand 25, for example by means of the screw 53.

In the closed position of the mold 1, the mold base 20 is immobilized in relation to the side wall 16 by means of a pair of jaws 54, each integral with a half-mold 16A, 16B, and which work with the groove of the ring 52, thus producing both the hold and the centering of the mold base 20.

To form the container 2 starting from the preform 3 (or more generally a blank), the following is carried out:

With the insert 29 being in the retracted position, first of all an operation for inserting the preform 3 (illustrated by dotted lines in FIG. 1) that was heated in advance to a temperature that is higher than the glass transition temperature of the material (of approximately 80° C. for the PET) into the mold 1 is carried out.

A pressurization phase that comprises the injection, into the preform 3, of a pressurized gas (such as air), preferably while stretching it by means of an elongation rod, is then carried out. The pressure during injection is increased from a pre-blow-molding pressure of approximately 7 bar to a blow-molding pressure that is greater than or equal to 15 bar, typically on the order of 25 bar to 30 bar (and able to go up to 40 bar). The material will then flatten against the side wall 16, against the molding face 22, and against the end face 30 of the insert 29, thus forming the container 2.

The insert 29 is always in its retracted position when the blow molding is carried out at the pressure that is higher than 15 bar. Under these conditions, the material faithfully takes the impression of the molding face 22 and of the end face 30.

The pressurization phase comprises a time lag during which the blow-molding pressure is maintained to ensure that the material takes the impression properly.

Then, during a depressurization phase, the inside volume of the thus formed container 2 is linked with the atmosphere (i.e., the free air).

The depressurization phase can include a flushing stage, which consists in linking the inside volume of the container 2 with a fluid source at a pressure that is intermediate between the pre-blow-molding pressure and the blow-molding pressure and thus ensuring that the inner face of the container 2 is cooled.

During (or optionally after) the depressurization, a boxing operation of the central area 10 of the bottom 8 of the container 2 is carried out, which operation consists in moving the insert 29 toward its protruding position, as shown in FIG. 3. Thus, a thrust is exerted against the central area 10 of the bottom of the container, bringing about an increase in the clearance of said central area in relation to the clearance that it has at the end of the blow molding.

In the illustrated example, this operation is carried out by pressurization of the lower chamber 41 and simultaneous depressurization of the upper chamber 40, which causes the piston 31 to abut against the upper wall 33 (and therefore the insert 29 in its protruding position).

Under the thrust of the insert 29, indicated by the arrow in the detail inset of FIG. 3, the bottom 8 of the container deforms from its initial configuration (illustrated by solid lines in FIG. 2 and by dotted lines in FIG. 3) that is produced by the blow molding, with the central area 10 rising toward the interior of the container 2 (as illustrated by solid lines in FIG. 3). With the cooling (or, inversely, the thermosetting) of the container 2 continuing, the material, in partial contact with the insert 29 that is regulated thermally, tends to become set in this deformed configuration.

The insert 29 is held in its protruding position for a predetermined duration (for example, on the order of several tenths of seconds), and then the insert 29 is replaced in its lower position (by simultaneous pressurization of the upper chamber 40 and depressurization of the lower chamber 41), which causes the piston 31 to abut against the lower wall 34. This replacement of the insert 29 into the lower position can be carried out after the lowering of the mold base 20 that accompanies the opening of the mold 1.

As can be seen in FIG. 4, the central area 10 of the bottom 8 of the container 2 is, at the outlet of the mold 2, in a raised configuration (illustrated by solid lines) in relation to a conventional configuration (illustrated by dotted lines) where the forming of the container 2 is carried out without the insert 29.
G1 denotes the clearance of the bottom 8 of the container in this raised configuration (by solid lines), i.e., the distance, measured axially (parallel to the axis X) between the central area 10 and the end of the seat 9 (which forms a placement plane for the container 2);
G0 denotes the clearance of a similar conventional bottom (by dotted lines).

Not only is the clearance G1 of the cooled container 2 greater than the clearance G0, but it has been verified that the clearance G1 remains strictly positive after its filling (and its capping), which ensures its stability not only in the medium term (and in particular during the operations for handling the container following its filling: labeling, conveying, plastic wrapping, palletization), but also in the long term, including during its use by a consumer.

Providing numerical values would not be considered to be limiting but is obviously possible. For a container 2 with a petaloid bottom (as illustrated), and a travel of the insert 29 of 5 mm, the increase in the clearance (i.e., the value of G1−G0) is 1.5 mm.

Different variants could be adopted without exceeding this framework. In particular, it is feasible for the regulation circuit 45 to perform at least in part a localized blow-molding function, applied to the bottom 8 of the container. For this purpose, the fluid that supplies the circuit 45 is preferably a gas, and the insert can be equipped with radial (optionally inclined) perforations 55 that make the conduit 46 empty onto an outer face of the insert 29, in the vicinity of the end face 30. Such perforations are illustrated by dotted lines in the detail insets of FIGS. 2 and 3.

The injection of fluid during boxing facilitates the separation of the container bottom 8 from the molding face 22 (and therefore its deformation) while minimizing the risk of cracking.

1. Method for manufacturing a container (2) that has a bottom (8) that is provided with a seat (9) and a central area (10) that is raised in relation to the seat (9), by blow molding or stretch blow molding, in a mold (1) of a blank (3) made of plastic material that was heated in advance to a temperature that is higher than the glass transition temperature of the material, which method comprises:
An operation for inserting the blank (3) into said mold (1), which mold comprises a side wall (16) that bears the impression of a body (4) of the container (2) and a mold base (20) that completes, with the side wall (16), the impression of the container (2) that is to be obtained, with this mold base (20) comprising a base unit (21) that has a molding face (22) in relief bearing the impression of at least the seat (9) of the container (2) and is provided with a central opening (28), with this mold base (20) also comprising an insert (29), mounted in the central opening (28) and provided with an end face (30) that bears the impression of the central area (10) of the bottom (8) of the container (2), which insert (29) can be moved in relation to the unit (21) between:
A retracted position in which the end face (30) extends in continuation of the molding face (22) of the unit (21), thus completing with the latter the impression of the bottom (8) of the container (2);
A protruding position in which the insert (29) projects in relation to the central opening (28);
further comprising:
A pressurization phase that comprises the injection, in the blank (3), in the retracted position of the insert (29), of a pressurized fluid to form the container (2);
A depressurization phase that comprises the linking of the thus formed container (2) with the atmosphere,
A boxing operation of the central area (10) of the bottom (8) of the container (2) that is thus formed and that consists, during or after the depressurization phase, in moving the insert (29) toward its protruding position in such a way as to exert pressure against said central area (10) of the bottom (8) of the container (2) and to increase the clearance of said central area (10) in relation to the clearance that it has at the end of the blow molding.

2. Method according to claim 1, wherein the travel of the insert (29) between a retracted position and protruding position is between 2 mm and 15 mm.

3. Method according to claim 2, wherein the travel of the insert (29) is approximately 5 mm.

4. Mold base (20) for the implementation of the method according to claim 1, wherein the insert (29) comprises a piston (31) that is mounted in translation in a jacket (32) that is integral with the base unit (21).

5. Mold base (20) according to claim 4, further comprising a circuit (45) for internal heat regulation.

6. Mold base (20) according to claim 5, wherein the heat regulation circuit (45) comprises a conduit (46) that is formed in the insert (29) for the circulation of a fluid.

7. Mold base (20) according to claim 6, wherein the insert (29) is equipped with radial perforations (55) that make the conduit (46) empty onto an outer face of the insert (29), in the vicinity of the end face (30).

8. Mold base (20) according to claim 6, wherein the conduit (46) is formed by a single piece and comprises an upstream section (46A) and a downstream section (46B) that are separated by a fabric (51).

9. Mold base (20) according to claim 8, wherein the insert (29) is produced by additive manufacturing.

10. Mold base (20) for the implementation of the method according to claim 2, wherein the insert (29) comprises a piston (31) that is mounted in translation in a jacket (32) that is integral with the base unit (21).

11. Mold base (20) for the implementation of the method according to claim 3, wherein the insert (29) comprises a piston (31) that is mounted in translation in a jacket (32) that is integral with the base unit (21).

12. Mold base (20) according to claim 7, wherein the conduit (46) is formed by a single piece and comprises an upstream section (46A) and a downstream section (46B) that are separated by a fabric (51).
